(19) United States
(12) Patent Application Publication
(10) Pub. No.: US 2022/0108427 A1
(43) Pub. Date: Apr. 7, 2022

(54) METHOD AND AN ELECTRONIC DEVICE FOR DETECTING AND REMOVING ARTIFACTS/DEGRADATIONS IN MEDIA

(71) Applicant: SAMSUNG ELECTRONICS CO., LTD., Suwon-si (KR)

(72) Inventors: Beomsu KIM, Suwon-si (KR); Balvinder SINGH, Bangalore (IN); Alok Shankarlal SHUKLA, Bangalore (IN); Jisung YOO, Suwon-si (KR); Narasimha Gopalakrishna PAI, Bangalore (IN); Prajit Sivasankaran NAIR, Bangalore (IN); Raj Narayana GADDE, Bangalore (IN); Sungsoo CHOI, Suwon-si (KR); Sirish Kumar PASUPULETI, Bangalore (IN)

(73) Assignee: SAMSUNG ELECTRONICS CO., LTD., Suwon-si (KR)

(21) Appl. No.: 17/550,751

(22) Filed: Dec. 14, 2021

Related U.S. Application Data
(63) Continuation of application No. PCT/KR2021/012602, filed on Sep. 15, 2021.

(30) Foreign Application Priority Data
Sep. 15, 2020 (IN) 202041039989
Jul. 19, 2021 (IN) 2020 41039989

(51) Int. Cl. G06T 5/00; G06N 20/00; G06F 16/58; G06F 16/583

(52) U.S. Cl. CPC G06T 5/001; G06F 16/583; G06F 16/5866; G06N 20/00

(57) ABSTRACT

Example embodiments include a method and an electronic device for detecting and removing artifacts/degradations in media. Embodiments may detect artifacts and/or degradations in the media based on tag information indicating at least one artifact included in the media. The detection may be triggered automatically or manually. Embodiments may generate artifact/quality tag information associated with the media to indicate artifacts and/or degradations present in the media, and may store the artifact/quality tag information as metadata and/or in a database. Embodiments may identify, based on the artifact/quality tag information associated with the media, at least one artificial intelligence (AI)-based media processing model to be applied to the media to enhance the media. The at least one AI-based media processing model may be configured to enhance at least one artifact detected in the media. Embodiments may enhance the media by applying the at least one AI-based media enhancement model to the media.

### CROSS-REFERENCE TO RELATED APPLICATIONS

This application is a Continuation Application of International Application PCT/KR2021/012602 filed on Sep. 15, 2021, which claims benefit of priority from Indian Patent Application No. 202041039989, filed on Jul. 19, 2021, and Indian Provisional Patent Application No. 202041039989, filed on Sep. 15, 2020, the disclosures of which are incorporated herein in their entireties by reference.

### BACKGROUND

### 1. Field

The present disclosure relates to image processing, and more particularly to methods and systems for detecting artifacts in media and enhancing the media by removing the artifacts using at least one artificial intelligence technique.

### 2. Description of the Related Art

Images stored in a user device may comprise low quality images and high quality images. If the user device has efficient processing and computational capabilities, media captured using a camera of the user device may be of high quality.

When social networking applications are accessed using the user device by connecting to the Internet, the user device can receive media, which may be stored in the user device. The quality of the media received from the social networking applications may typically be of low quality, as significant compression may be applied to the media for saving bandwidth involved in transfer of media, for example. Due to the compression, the resolution of the media may decrease. Thus, the media stored in the user device may be media of a varying range of qualities.

If or when a user migrates to another new user device that comprises a camera having more advanced features than the camera of the earlier user device, and if or when processing and computational capabilities of the new user device may be more efficient compared to the earlier used user device, then media captured using the camera of the new user device may be of higher quality. Therefore, if or when the user transfers the media stored in the earlier user device to the new user device, then the range of variation of qualities of the media stored in the new user device may become greater.

The media transferred from the earlier used user device may have artifacts created during the capturing of the media. Low sensitivity of the camera and single frame processing may result in artifacts such as noise in the captured media if or when the media has been captured in low light conditions. Alternatively or additionally, motion of the camera may result in artifacts such as blur in the captured media. Moreover, poor environmental conditions and/or an unstable capturing position may result in artifacts such as reflections and/or shadows in the captured media. Currently, there are no means available to the new user device to improve or enhance the media stored in the new user device.

### SUMMARY

Aspects of the present disclosure provide methods and systems for enhancing quality of media stored in a device and/or a cloud by detecting artifacts and/or degradations in the media, identifying at least one Artificial Intelligence (AI)-based media processing model for nullifying the detected artifacts and/or degradations, and enhancing the media by applying the at least one AI-based media processing model in a predetermined order for enhancing the media.

Some embodiments of the present disclosure may comprise triggering the detection of artifacts and/or degradations in the media stored in a device. The triggering may be performed either automatically or manually invoked by user of the device. The device according to some embodiments may be configured to automatically trigger the detection of the artifacts if or when the device is idle, if or when the device is not being utilized, or if or when the media is stored in the device.

Alternative or additional embodiments of the present disclosure may comprise generating artifact/quality tag information associated with the media to indicate specific artifacts and/or degradations included in the media and store the artifact/quality tag information either along with the media as metadata, and/or in a dedicated database.

Alternative or additional embodiments of the present disclosure may comprise identifying, based on the artifact/quality tag information associated with the media, the at least one AI-based media processing model that needs to be applied to the media to enhance the media.

Alternative or additional embodiments of the present disclosure may comprise selecting a pipeline of AI-based media processing models arranged in a predetermined order. The AI-based media processing models can be applied to the media in the predetermined order, indicated in the pipeline, to enhance the media. The pipeline may be obtained based on feature vectors of the image such as the artifact/quality tag information associated with the media, identified AI-based media processing models to be applied to the media, dependency amongst the identified AI-based media processing models, aesthetic score of the media, media content, and the like. The pipeline may be obtained using a previous result from enhancing a reference media, having same and/or similar feature vectors with a current media to be enhanced, by applying the AI-based media processing models in the predetermined order.

Alternative or additional embodiments of the present disclosure may ensure optimality of the enhancement by determining that an aesthetic score of the media has reached a maximum value after the enhancement, wherein the AI-based media processing models are applied recursively to the media, to enhance the media, until the aesthetic score of the media has reached the maximum value.

Alternative or additional embodiments herein may perform at least one operation comprising detecting artifacts in the media, generating artifact tag information associated with the media, and enhancing the media using at least one identified AI-based media processing model, in at least one of the device and the cloud.

Alternative or additional embodiments herein may perform the at least one operation in the background automatically or in the foreground on receiving commands from a user of the device to perform the at least one operation.

Accordingly, the embodiments of the present disclosure provide methods and systems for enhancing quality of media by detecting presence of artifacts and/or degradations in the media and nullifying the artifacts and the degradations using one or more AI-based media processing models.

In some embodiments, a method for enhancing media is provided. The method comprises detecting at least one artifact included in the media based on tag information indicating the at least one artifact included in the media, identifying at least one AI-based media enhancement model for enhancing the detected at least one artifact, and applying the at least one AI-based media enhancement model to the media for enhancing the media.

In some embodiments, the tag information regarding the media is encrypted and the tag information with the media is stored as metadata of the media.

In some embodiments, the at least one artifact in the media is detected in case that an aesthetic score of the media is less than a predefined threshold. In some embodiments, the identifying the at least one AI-based media enhancement model further comprises identifying a type of the at least one artifact included in the media based on the tag information and determining the at least one AI-based media enhancement model according to the identified type of the at least one artifact.

In some embodiments, the determining the at least one AI-based media enhancement model comprises determining a type of the at least one AI-based media enhancement model and an order of the at least one AI-based media enhancement model. If or when a plurality of AI-based media enhancement models are determined for enhancing the at least one artifact detected in the media, the plurality of AI-based media enhancement models are applied to the media in a predetermined order.

In some embodiments, the determining the at least one AI-based media enhancement model further comprises: determining a type of the at least one AI-based media enhancement model and an order of the at least one AI-based media enhancement model for enhancing a reference media, storing the determined type and the order of the at least one AI-based media enhancement model for enhancing the reference media in a database, obtaining feature vectors of the media, and determining the type and the order of the at least one AI-based media enhancement model for enhancing the media based on the determined type and the order of the at least one AI-based media enhancement model for enhancing the reference media, wherein the reference media has equal or similar feature vectors with the media. The feature vectors comprise at least one of metadata of the media, the tag information pertaining to the media, aesthetic score of the media, the plurality of AI-based media processing models to be applied to the media, dependencies among the plurality of AI-based media processing models, and the media.

In some embodiments, detection of the at least one artifact in the media, identification of the at least one AI-based media enhancement model, and application of the at least one AI-based media enhancement model to the media is performed in an electronic device of a user. Alternatively, the detection of the at least one artifact in the media, identification of the at least one AI-based media enhancement model, and application of the at least one AI-based media enhancement model to the media is performed in a cloud, wherein the detection of the at least one models in the media is initiated after the media is uploaded to the cloud.

In some embodiments, an electronic device for enhancing media is provided. In such embodiments, the electronic device comprises a memory, one or more processors communicatively connected to the memory and the one or more processors are configured to: detect at least one artifact included in the media based on tag information indicating the at least one artifact included in the media, identify at least one AI-based media enhancement model for enhancing the detected at least one artifact, and apply the at least one AI-based media enhancement model to the media for enhancing the media.

In some embodiments, the one or more processors are configured to encrypt the tag information regarding the media and storing the tag information with the media as metadata of the media.

In some embodiments, the at least one artifact in the media is detected in case that an aesthetic score of the media is less than a predefined threshold.

In an embodiment, the one or more processors are further configured to: identify a type of the at least one artifact included in the media based on the tag information, and determine the at least one AI-based media enhancement model according to the identified type of the at least one artifact.

In some embodiments, the one or more processors are further configured to determine a type of the at least one AI-based media enhancement model and an order of the at least one AI-based media enhancement model. If or when a plurality of AI-based media enhancement models are determined for enhancing the at least one artifact detected in the media, the plurality of AI-based media enhancement models are applied to the media in a predetermined order.

In some embodiments, the one or more processors are further configured to: determine a type of the at least one AI-based media enhancement model and an order of the at least one AI-based media enhancement model for enhancing a reference media, store the determined type and the order of the at least one AI-based media enhancement model for enhancing the reference media in a database, obtain feature vectors of the media, and determine the type and the order of the at least one AI-based media enhancement model for enhancing the media based on the determined type and the order of the at least one AI-based media enhancement model for enhancing the reference media, wherein the reference media has equal or similar feature vectors with the media. The feature vectors comprise at least one of metadata of the media, the tag information pertaining to the media, aesthetic score of the media, the plurality of AI-based media processing models to be applied to the media, dependencies among the plurality of AI-based media processing models, and the media.

In some embodiments, the electronic device is located on a cloud. The one or more processors are configured to initiate the detection of the at least one artifact in the media either automatically when the electronic device is in idle status or on receiving commands from a user.

Some embodiments may comprise analyzing the media to detect the artifacts and/or the degradations wherein the analysis can be triggered automatically or manually. Alternative or additional embodiments may comprise determining aesthetic scores of the media and saliency of the media. Alternative or additional embodiments may comprise prioritizing the media for enhancement based on the aesthetic scores and the saliency of the media. Alternative or additional embodiments may comprise generating artifact/quality tag information, which indicates the artifacts and/or degradations that have been detected in the media. The artifact/quality tag information allows associated between the media with the artifacts and/or degradations that have been detected in the media. The artifact/quality tag information may be stored either along with the media as metadata. Alternatively or additionally, the artifact/quality tag information may be stored in a dedicated database. The database may indicate the media and artifacts and/or degradations associated with the media. The artifact/quality tag information may allow users to classify media based on specific artifacts and/or degradations present in the media and initiate enhancement of media having specific artifacts and/or degradations.

In some embodiments notifications can be provided to the users for indicating the media that can be enhanced. Alternative or additional embodiments may comprise identifying one or more AI-based media processing models for enhancing the media. Alternative or additional embodiments may comprise enhancing the media, (improving the quality of the media) by applying the one or more AI-based media processing models (AI-based enhancement and artifact removal models) to the media. The identification of the one or more AI-based media enhancement models can be initiated on receiving commands (from the users). Alternatively or additionally, the one or more AI-based media processing models can be automatically identified. Alternative or additional embodiments may comprise identifying the AI-based media processing models that need to be applied to the media to enhance the media based on the artifact/quality tag information associated with the media.

Some embodiments may comprise creating a pipeline of the AI-based media processing models, which may be applied to the media to enhance the media (e.g., multiple AI-based media processing models need to be applied to the media to enhance the media). In alternative or additional embodiments, the AI-based media processing models may be applied to the media in a predetermined order as indicated in the pipeline. The pipeline can be created offline (training phase), wherein correspondence is created between media and sequences of AI-based media processing models to be applied to the media (e.g., for enhancing the media). The sequences may be determined during the training phase and can be referred to as the predetermined order during the application phase. The pipeline can be created using an AI system, which is trained with different varieties of degraded media and enhancement of the media, wherein the enhancement involves creating multiple enhancement pipeline comprising of AI-based media processing models arranged in different orders, and finding the optimal enhancement pipeline for the media. Alternative or additional embodiments may comprise creating the correspondence based on the artifact tag information associated with the media, identified AI-based media processing models to be applied to the media, dependency amongst the identified AI-based media processing models, aesthetic score of the media, media content, and the like.

Some embodiments may comprise ensuring the optimality of the enhancement of the media by determining that an aesthetic score of the media has reached a maximum value after the enhancement. Alternative or additional embodiments may comprise applying the AI-based media processing models recursively to the media and determining the aesthetic score of the media, until the aesthetic score of the media has reached the maximum value. In some embodiments, the operations comprising detecting artifacts and/or degradations in the media, generating artifact/quality tag information associated with the media, identifying one or more AI-based media processing model for enhancing the media and enhancing the media using the identified AI-based media processing model, can be performed in a device or a cloud.

An example embodiment includes a method for enhancing media, comprising detecting at least one artifact included in the media based on tag information indicating the at least one artifact included in the media. The method includes identifying at least one AI-based media enhancement model. The at least one AI-based media enhancement model being configured to enhance the at least one artifact detected in the media. The method further includes enhancing the media by applying the at least one AI-based media enhancement model to the media.

Another example embodiment includes an electronic device for enhancing media, comprising a memory and one or more processors communicatively connected to the memory. The one or more processors are configured to detect at least one artifact included in the media based on tag information indicating the at least one artifact included in the media. The one or more processors are configured to identify at least one AI-based media enhancement model. The at least one AI-based media enhancement model being configured to enhance the at least one artifact detected in the media. The one or more processors are further configured to enhance the media by applying the at least one AI-based media enhancement model to the media.

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an electronic device configured to enhance the quality of media stored in the device by detecting at least one of artifacts and degradations in the media, and using one or more AI-based media enhancement models for nullifying the artifacts and/or the degradations in the media, according to embodiments of the disclosure;

FIG. 2A illustrates an example of generation of artifact/quality tag information based on the detection of artifacts and/or degradations in the media, according to embodiments of the disclosure;

FIG. 2B illustrates a tag encryptor according to embodiments of the disclosure;

FIG. 3 illustrates an example clustering of images based on the artifact/quality tag information associated with the images, according to embodiments as disclosed herein;

FIG. 4 illustrates examples of AI-based media enhancement models included in an AI media enhancement unit, according to embodiments as disclosed herein;

FIGS. 5A and 5B illustrate example image enhancements, wherein the enhancements have been obtained by applying multiple AI-based media enhancement models in predetermined orders, according to embodiments as disclosed herein;

FIG. 6 illustrates supervised and unsupervised training of an AI enhancement mapper to create pipelines of AI-based media enhancement models, according to embodiments as disclosed herein;

FIGS. 7A, 7B, 7C, and 7D each illustrate an example enhancement of an image using AI-based media enhancement models arranged in a pipeline, according to embodiments as disclosed herein;

FIG. 8 illustrates an example of unsupervised training of the AI enhancement mapper enabling correspondence between a pipeline of AI-based media enhancement models and an image with particular artifacts and/or degradations, according to embodiments as disclosed herein;

FIG. 9 illustrates an example of supervised training of the AI enhancement mapper for enabling correspondence between a pipeline of AI-based media enhancement models and an image having particular artifacts and/or degradations, according to embodiments as disclosed herein;

FIGS. 10A, 10B, 10C, and 10D illustrate an example user interface (UI) for displaying options to a user to select images, stored in the electronic device, for enhancement, and displaying an enhanced version of a selected image, according to embodiments as disclosed herein;

FIG. 11 depicts a flowchart of a method for enhancing the quality of media by detecting a presence of artifacts and/or degradations in the media and nullifying the artifacts and the degradations using one or more AI-based media enhancement models, according to embodiments as disclosed herein; and

FIG. 12 illustrates a block diagram of an electronic device, according to embodiments as disclosed herein.

### DETAILED DESCRIPTION OF EXEMPLARY EMBODIMENTS

The aspects described herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments. The examples used herein are intended merely to facilitate an understanding of ways in which the embodiments may be practiced and to further enable those of skill in the art to practice the embodiments. Accordingly, the examples should not be construed as limiting the scope of the embodiments herein. Further, expressions such as “at least one of a, b, and c” should be understood as including only a, only b, only c, both a and b, both a and c, both b and c, all of a, b, and c, or other variations of thereof.

Embodiments herein disclose methods and systems for enhancing quality of media by detecting presence of artifacts and/or degradations in the media and nullifying the artifacts and/or the degradations using one or more Artificial Intelligence (AI)-based media enhancement models. The triggering of the detection of artifacts and/or degradations in the media can be automatic or manual. Some embodiments may comprise generating artifact/quality tag information associated with the media for indicating specific artifacts and/or degradations present in the media and/or storing the artifact/quality tag information along with the media as metadata, and/or in a dedicated database. Some embodiments may comprise triggering initiation of the media enhancement. The media enhancement may comprise identifying at least one AI-based media enhancement model that needs to be applied to the media to enhance the media. The at least one AI-based media enhancement model may be identified based on the artifact/quality tag information associated with the media.

Alternative or additional embodiments may comprise creating a pipeline, which may comprise AI-based media enhancement models. The AI-based media enhancement models can be applied to the media in a sequential order, as indicated in the pipeline, to enhance the media. In some embodiments, the creation of the pipeline may be based on the artifact/quality tag information associated with the media, identified AI-based media enhancement models to be applied to the media, dependency amongst the identified AI-based media enhancement models, aesthetic score of the media, media content, and the like. Alternative or additional embodiments may comprise computing the aesthetic scores of the media prior to, and/or after, the identified AI-based media enhancement models are applied to the media. Alternative or additional embodiments may comprise determining whether the aesthetic scores have improved after media enhancement. If or when the aesthetic scores improve, some embodiments may comprise applying the identified AI-based media enhancement models to the media recursively, until the aesthetic scores stop improving. That is, the enhancing process using the identified AI-based media enhancement models may be applied recursively until the aesthetic scores of the media had reached a maximum value. Thus, the optimality of the media enhancement can be determined by determining that the aesthetic score of the media has reached a maximum value after the enhancement. The AI-based media enhancement models can be applied recursively to the media, to enhance the media, until the aesthetic score of the media reaches the maximum value. If or when no further enhancement are made, the AI-based media enhancement models may be stopped.

In some embodiments, at least one operation comprising detecting artifacts in the media, generating artifact/quality tag information associated with the media, identifying at least one AI-based media enhancement models to enhance the media, and enhancing the media using the at least one identified AI-based media enhancement model, can be performed in at least one of a user device and/or a cloud. In alternative or additional embodiments, the at least one operation can be performed in the user device automatically in background or in the foreground on receiving commands from a user of the device to perform the at least one operation.

If or when the media enhancement is performed in the cloud, the user can retrieve or download the enhanced media from the cloud. In some embodiments, the at least one operation may be performed in the cloud automatically, if or when the media is stored in the cloud. In alternative or additional embodiments, the at least one operation may be performed in the cloud in response to receiving one or more commands from the user to perform the at least one operation, if or when the media is stored in the cloud. In alternative or additional embodiments, the at least one operation may be performed in the cloud after the media has been uploaded from the user device to the cloud. The media may not be required to be stored in the cloud, and after AI processing, the media can be stored in a separate database and/or retransmitted to the user device. The at least one operation may be performed in the cloud either automatically or in response to receiving the one or more user commands to perform the at least one operation.

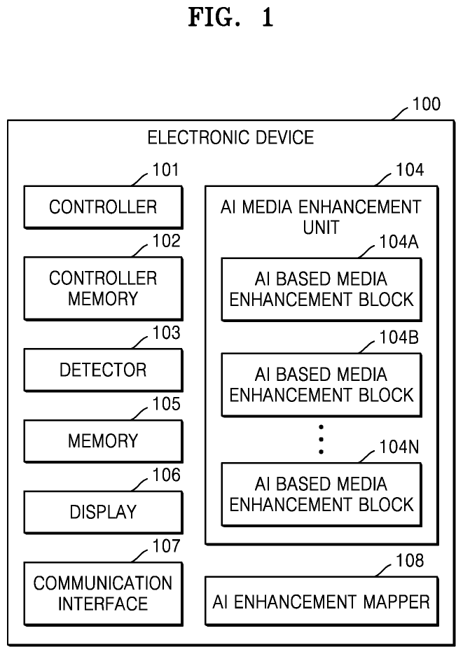

Referring now to the drawings, and more particularly to FIGS. 1 through 12, where similar reference characters denote corresponding features consistently throughout the figures, there are shown preferred embodiments.

FIG. 1 illustrates an electronic device 100 configured to enhance the quality of media stored in the device by detecting impairments in the media and using one or more AI-based media enhancement models for nullifying the impairments included in the media, according to embodiments as disclosed herein. As illustrated in FIG. 1, the electronic device 100 comprises a controller 101, a controller memory 102, a detector 103, an AI media enhancement unit 104, a memory 105, a display 106, a communication interface 107, and an AI enhancement mapper 108. The AI media enhancement unit 104 can comprise one or more AI-based media enhancement blocks 104A-104N. For example, in an embodiment, the AI media enhancement unit 104 may comprise a plurality of AI-based media enhancement blocks 104A-104N (e.g., AI-based media enhancement block 104A, AI-based media enhancement block 104B, and AI-based media enhancement block 104N). The AI-based media enhancement blocks 104A-104N may be configured to perform one or more AI-based media enhancement models to enhance the media. In some embodiments, the AI media enhancement unit 104 and/or the AI enhancement mapper 108 may assign one or more AI-based media enhancement models to an AI-based media enhancement block (e.g., 104A-104N).

In some embodiments, the controller 101, the controller memory 102, the detector 103, the AI media enhancement unit 104, the memory 105, the display 106, the communication interface 107, and the AI enhancement mapper 108 can be implemented in the electronic device 100. Examples of the electronic device 100 can be, but not limited to, a smart phone, a Personal Computer (PC), a laptop, a desktop, an Internet of Things (IoT) device, and the like.

In other embodiments, the controller 101, the controller memory 102, the detector 103, the AI media enhancement unit 104, and the AI enhancement mapper 108 can be implemented in an electronic device of a cloud (e.g., virtual device, not shown). The electronic device 100 may comprise the memory 105, the display 106, and the communication interface 107. The cloud device may comprise a memory. The electronic device 100 can store media (e.g., originally stored in the memory 105 of the device) in the cloud memory by sending the media to the cloud using the communication interface 107. The portion of the memory 105 storing the media can be synchronized with the cloud memory for enabling automatic transfer (upload) of media from the electronic device 100 to the cloud. Once the media has been enhanced (e.g., quality of the media has been improved), the enhanced media can be stored in the cloud memory. The electronic device 100 can receive (e.g., download) the enhanced media from the cloud using the communication interface 107 and store the enhanced media in the memory 105.

In other embodiments, the AI media enhancement unit 104 and the AI enhancement mapper 108 can be stored in the cloud. In such embodiments, the electronic device 100 may comprise the controller 101, the controller memory 102, the detector 103, the memory 105, the display 106, and the communication interface 107. The electronic device 100 can send selected media and the impairments detected in the selected media to the cloud, for enhancement of the media using particular AI-based media enhancement models. The AI media enhancement unit 104 stored in the cloud, which may comprise the AI-based media enhancement blocks 104A-104N, can apply the particular AI-based media enhancement models to the selected media. As such, the electronic device 100 may perform media enhancement using AI-based media enhancement models that can be considered as overly burdensome for the electronic device 100, particularly in terms of processing, computational, and storage requirements. The electronic device 100 can impose constraints on AI-based media enhancement blocks 104A-104N (for enhancing the media using the particular AI-based media enhancement models), if or when the AI-based media enhancement blocks 104A-104N and the AI enhancement mapper 108 are stored in the electronic device 100. The electronic device 100 can receive, using the communication interface 107, enhanced media from the cloud, and store the enhanced media in the memory 105.

The controller 101 can trigger detection of impairments included in the media. The impairments may comprise artifacts and/or degradations. The media can refer to images and videos stored in the memory 105 of the electronic device 100. The media stored in the memory 105 may comprise media captured using a camera (not shown) of the electronic device 100, media obtained from other devices, media obtained through social media applications/services, and the like. In some embodiments, the controller 101 can automatically trigger the detection of artifacts and/or degradations. For example, the detection can be triggered at a specific time of the day if or when the device is not likely to be in use. Alternatively or additionally, the detection can be triggered if or when the processing and/or computational load on the electronic device 100 is less than (e.g., does not exceed) a predefined threshold. Alternatively or additionally, the detection can be triggered if or when the electronic device 100 is in an idle state. In other embodiments, the controller 101 can trigger the detection of artifacts and/or degradations in the media in response to receiving a command (e.g., from an user) to trigger the detection.

In some embodiments, the controller 101 may be present in the cloud, and the electronic device 100 can send selected media to be enhanced to the cloud. For example, the user of the electronic device 100 can connect to the cloud and send at least one command to the cloud to trigger the detection of artifacts and/or degradations in the media sent to the cloud.

In other embodiments, the electronic device 100 can prioritize media stored in the memory 105 for media enhancement. For example, the electronic device 100 can determine aesthetic scores of the media stored in the memory 105. That is, media with low aesthetic scores and/or with a moderate-high saliency can be prioritized for media enhancement.

If or when the controller 101 has triggered the detection of artifacts and/or degradations included in the media, the detector 103 can analyze the media. The analysis may comprise detecting artifacts and/or degradations included in the media stored in the memory 105. The detector 103 may comprise one or more AI modules to detect the artifacts and/or degradations in the media. The detector 103 may be configured to mark the media enhancement if or when the detector 103 detected artifacts and/or degradations in the media. In some embodiments, the detector 103 can be a single monolithic deep neural network, which can detect and/or identify artifacts and/or degradations included in the media. Examples of artifacts included in the media may comprise shadows and reflections. Examples of degradations present in the media may comprise a presence of blur and/or noise in the media, under or over exposure, low resolution, low light (insufficient brightness), and the like.

The detector 103 can determine the resolutions of the media (e.g., images, videos) based on camera intrinsic parameters, which can be stored along with the media as metadata. The detector 103 can determine image type (e.g., color image, graphics image, grey scale image, and the like), and effects applied to the images (such as “beauty” effect and/or Bokeh effect). In some embodiments, the detector 103 can compute the aesthetic scores of the images. For example, the aesthetic scores may fall within a range, such as from 1 (worst) to 10 (best). In another example, the aesthetic scores may fall within a range of 1 (best) to 10 worst). In yet another example, the aesthetic scores may fall within a range of 1 to 100. In some embodiments, the detector 103 can determine histograms pertaining to the images (e.g., media) for determining the pixel distributions in the images. The histograms of the images may be used by the detector 103 to determine corresponding exposure levels of the images. For example, the detector 103 may assign an exposure level to each image, such as a normal exposure level (uniform distribution), an over exposure level, an under exposure level, and/or both an under exposure level and an over exposure level.

The detector 103 can perform object detection on the media. That is, the detector 103 may identify objects in the images and/or classify the objects according to a type of the identified objects, such as presence of humans, animals, things, and the like. In some embodiments, the detector 103 can perform other operations on the media, such as face recognition to detect and/or identify humans in the images. Alternatively or additionally, the detector 103 can also perform image segmentation.

In some embodiments, the detector 103 may comprise a low-light classifier, a blur classifier, and/or a noise classifier. The low-light classifier of the detector 103 may determine whether the image has been captured in low-light and/or whether the brightness of the image is sufficient. For example, the detector 103 may indicate a result of the determination of whether the image has been captured in low-light as a Boolean flag (e.g., ‘true’ or ‘false’). That is, if or when an image has been captured under low-light conditions, a low-light tag indicating the low-light condition of the image may be set as ‘true’ or a binary value of one. In another example, if or when the image has been captured under normal lighting conditions, the low-light tag indicating the low-light condition of the image may be set as ‘false’ or a binary value of zero.

In some embodiments, the blur classifier of the detector 103 may utilize the results obtained from the object detection and/or the image segmentation to determine whether or not there is a presence of blur in the image and the type of blur (if or when blur is present) in the image. For example, the type of blur in an image may be indicated as at least one of ‘Defocus’, ‘Motion Blur’, ‘False’ (no Blur), ‘Studio Blur’, and ‘Bokeh blur’. That is, a blur tag of the image may be set according to the classification of the blur type.

In some embodiments, the noise classifier of the detector 103 may utilize the results obtained from the object detection and/or the image segmentation to determine whether or not there is a presence of noise in the image. For example, a determination of whether noise is present in the image may be indicated by a Boolean flag (e.g., ‘true’ or ‘false’). That is, if or when noise is present in the image, a noise tag indicating whether the noise is present in the image may be set as ‘true’ or a binary value of one. In another example, if or when the noise is not present in the image, the noise tag of the image may be set as ‘false’ or a binary value of zero.

FIG. 1 shows an exemplary electronic device 100, but it is to be understood that other embodiments are not limited thereon. In other embodiments, the electronic device 100 may comprise less or more number of units. Further, the labels or names of the units of the device are used only for illustrative purpose and does not limit the scope of the invention. One or more units may be combined together to perform same or substantially similar function in the device.

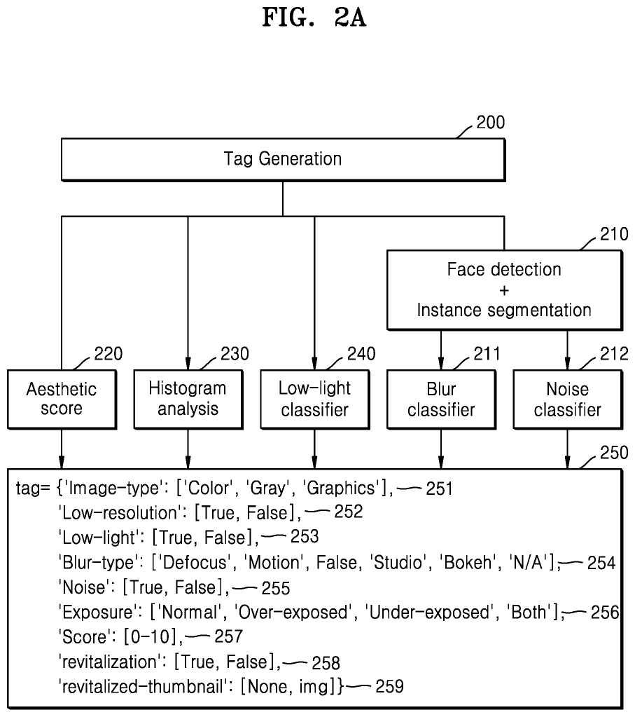

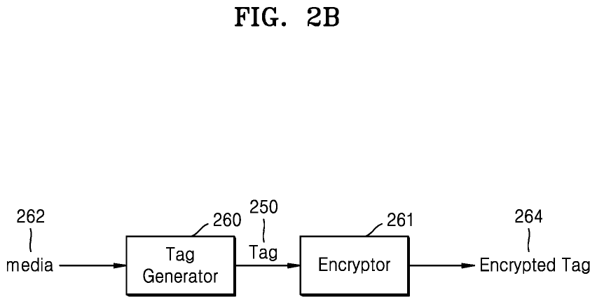

FIG. 2A illustrates an example of generation of artifact/quality tag information of media (e.g., image, video) based on the detection of artifacts and/or degradations in the media, according to embodiments of the disclosure. As shown in FIG. 2A, a tag generation process 200 may generate artifact/quality tag information 250. In some embodiments, the detector 103 may perform the tag generation process 200. That is, the detector 103 may generate the artifact/quality tag information 250 based on artifacts and/or degradations detected in the media. For example, the detector 103 may perform a face detection and instance segmentation process 210 to detect and/or identify human objects comprised in the media. Alternatively or additionally, the detector 103 may provide the results produced by the face detection and instance segmentation process 210 to a blur classifier 211. That is, the detector 103 may, with the blur classifier 211, detect a presence of blur in the media and/or classify the detected blur, based on the results produced by the face detection and instance segmentation process 210. For example, the detector 103 may generate, using the blur classifier 211, an indication of a blur type (e.g., ‘defocus’, ‘motion’, ‘false’, ‘studio’, ‘bokeh’) and add the output of the blur classifier 211 to the artifact/quality tag information 250, as blur-type tag 254.

In some embodiments, the detector 103 may provide the results produced by the face detection and instance segmentation process 210 to a noise classifier 212. That is, the detector 103 may, with the noise classifier 212, detect a presence of noise in the media, based on the results produced by the face detection and instance segmentation process 210. For example, the detector 103 may generate, using the noise classifier 212, an indication of a noise presence (e.g., ‘true’, ‘false’) and add the output of the noise classifier 212 to the artifact/quality tag information 250, as noise tag 255.

In other embodiments, the detector 103 may measure an aesthetic score 220 of the media and add the aesthetic score 220 to the artifact/quality tag information 250 as score tag 257. Alternatively or additionally, the detector 103 may be configured to perform a histogram analysis 230 to measure the quality of the media, such as an exposure level, for example. The detector 103 may be configured to add the exposure level to the artifact/quality tag information 250 as exposure tag 256.

In some embodiments, the detector 103 may determine, using a low-light classifier 240, whether the media has been captured under low-light conditions. Alternatively or additionally, the detector 103 may be configured to add the result of the low-light condition determination made by the low-light classifier 240 to the artifact/quality tag information 250 as low-light tag 253.

Consequently, the quality of the media may be determined based on the presence of artifacts such as reflection and shadow, the presence of blur and the type of blur, the presence of noise, whether the media was captured in low-light, a resolution (e.g., high, low) of the media, an exposure level of the media, and/or an aesthetic score of the media. For example, the quality of an image may be considered as low if or when the blur type is ‘defocus’ or ‘motion’, noise is present in the image, the image has been captured in low-light, the resolution of the image is low, the exposure level of the image is not normal (e.g., ‘under exposed’ or ‘over exposed’), and the aesthetic score is low. In some embodiments, the blur in the image may a result of a lack of focus or motion of a camera while the image was captured. That is, the factors degrading the quality of the image can be considered as degradations.

In some embodiments, the detector 103 may generate artifact/quality tag information 250 indicating characteristics of the image and/or defects included in the image. For example, the artifact/quality tag information 250 may comprise an image type (e.g., image-type tag 251), low-resolution information on whether the resolution of image is low (e.g., low-resolution tag 252), low-light information on whether the image has been captured in a low-light condition (e.g., low light tag 253), a type of blur of the image (e.g., blur-type tag 254), noise information (e.g., noise tag 255), exposure information indicating an exposure level of the image (e.g., exposure 256), aesthetic score information (e.g., score tag 257), information indicating whether the image needs to be revitalized (e.g., revitalization tag 258), and a revitalized thumbnail image (e.g., revitalized-thumbnail tag 259).

In some embodiments, the detector 103 may output the artifact/quality tag information 250 to the controller 101. The controller 101 may store the artifact/quality tag information 250, obtained from the detector 103, in the controller memory 102 and/or the memory 105. Alternatively or additionally, the detector 103 may store the artifact/quality tag information 250 in a memory storage separate from the electronic device 100, such as a cloud database, for example. In other embodiments, the controller 101 may generate a database for storing the media and the related artifact/quality tag information. Alternatively or additionally, the media stored in the database may be linked with the associated artifact/quality tag information pertaining to the media. In some embodiments, the database may be stored in the controller memory 102. In other embodiments, the detector 103 may store the artifact/quality tag information 250 associated with the media along with the media in the memory 105. Alternatively or additionally, the artifact/quality tag information may be embedded with the media in an exchangeable media file format and/or in an extended media file format. That is, the artifact/quality tag information may be stored as metadata of the media file. In some embodiments, the media may be stored in a database outside of the electronic device 100 such as cloud storage. That is, the media and the related artifact/quality tag information may be stored in the cloud storage.

In some embodiments, the artifact/quality tag information may be encrypted. FIG. 2B illustrates a tag encryptor according to embodiments of the disclosure. In some embodiments, the tag generator 260 may generate artifact/quality tag information 250 by analyzing the media 262 based on the artifacts or degradation included in the media 262, as described in reference to FIG. 2A. Alternatively or additionally, the encryptor 261 may encrypt the artifact/quality tag information 250 resulting in the encrypted artifact/quality tag information 264. In some embodiments, the tag generator 260 and the encryptor 261 may be comprised by the detector 103. The encrypted artifact/quality tag information 264 associated with the media 262 may be stored along with the media 262. As such, if or when the media 262 is sent to other devices through a wired network, a wireless network or different applications/services, the encrypted artifact/quality tag information 264 associated with the media 262 may be also sent with the media 262. By using encrypted information, only authorized devices may access the artifact/quality tag information 250 of the media 262. For example, a decryption key and/or decryption method may only be known to or shared by the authorized devices. That is, the authorized devices may be capable of decrypting the encrypted artifact/quality tag information 264 using the decryption key and/or the decryption method. As such, only authorized devices may be allowed to access the encrypted artifact/quality tag information 264 associated with the media 262, because only the authorized devices may decrypt the encrypted artifact/quality tag information 264 associated with the media 262. Consequently, only authorized devices may enhance the media 262 by nullifying the artifacts and/or degradations detected in the media 262 indicated in the decrypted artifact/quality tag information.

In some embodiments, transmission of the media 262 from the electronic device 100 to the other devices (having the controller 101 and the detector 103) may cause a loss in the quality of the transferred media due to noise, compression, and other such factors. In such embodiments, the artifact/quality tag information may need to be regenerated regarding the transferred media. However, the regeneration latency at the other devices may be reduced as the other devices may not need to detect the presence of artifacts such as shadows and/or reflections, as well as, degradations such as low-light conditions. That is, the electronic device 100 may send the encrypted artifact/quality tag information 264 of the media 262 along with the media 262 and the other devices (if or when authorized by the electronic device 100) may decrypt the encrypted artifact/quality tag information 264 of the media 262. Thus, the other devices may regenerate and/or update the artifact/quality tag information 250 using the encrypted artifact/quality tag information 264 transferred along with the media 262.

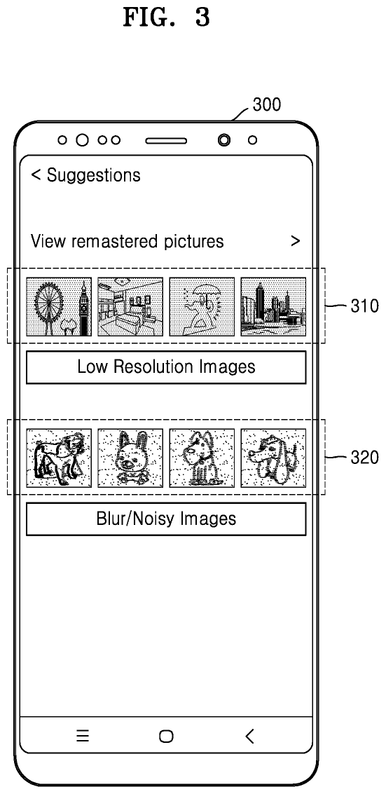

FIG. 3 illustrates an example of a clustering of images based on the artifact/quality tag information associated with the images, according to embodiments of the disclosure. As illustrated in FIG. 3, the images in the electronic device 300 may be grouped into clusters based on similar artifacts and/or degradations. The electronic device 100 depicted in FIG. 3 may be similar in many respects to the electronic devices described above with reference to FIGS. 1 and 2, and may include additional features not mentioned above.

The electronic device 300 may classify the imaged stored in the electronic device 300 based on the type of artifacts and degradation. Then, the electronic device 300 may display grouped images based on the type of artifacts and degradation. For example, the electronic device 300 may display low resolution images 310 and blur/noisy images 320 in groups as illustrated in FIG. 3. The user may issue commands to the electronic device 300 to display (e.g., on the display 106) images having degradations such as blur and noise (e.g., blur/noisy images 320), and/or images with low resolution (e.g., low resolution images 310). In some embodiments, in response to the commands issued by the user, a controller of the electronic device 300 (e.g., the controller 101) may search a database stored in the electronic device 300 (e.g., controller memory 102 and/or memory 105) to determine whether the database comprises low resolution images and/or blur/noisy images. That is, the electronic device 300 may determine whether the database contains one or more images associated with artifact/quality tag information 250 indicating the presence of degradations such as blur and/or noise, and/or images associated with artifact/quality tag information 250 indicating that a low resolution.

Alternatively or additionally, the images associated with the artifact/quality tag information 250 indicating a presence of artifacts (e.g., reflections and/or shadows) and/or a presence of degradations (e.g., low-light conditions) may be displayed in groups classified according to the type of the artifact and/or degradation. In some embodiments, the electronic device 300 may be configured to display a User Interface (UI) (e.g., on the display 106) indicating clusters of images with similar artifacts and degradations (e.g., low resolution images 310, blur/noisy images 320). As such, selection of media (e.g., images or videos) that needs to be enhanced may be facilitated.

In some embodiments, the controller 101 may trigger the initiation of media enhancement. The initiation of media enhancement may be triggered manually or automatically. That is, the electronic device 300 may be ready to receive commands requesting to initiate enhancement of the images displayed in the clusters of images after the clusters of images with similar artifacts and/or degradations have been generated and displayed. For example, the user may select the images to be enhanced and input a request to enhance the selected image using the UI provided by the display 106. In response to receiving the request to enhance the images selected by the user, the electronic device 300 may initiate the media enhancement process.

In some embodiments, an automatic triggering of the detection, by the controller 101, of artifacts and/or degradations in media may also cause an automatic triggering of the initiation of the media enhancement process, by the controller 101. In other embodiments, the media enhancement process may be performed by the controller 101 in the cloud. In such embodiments, the electronic device 300 storing the media may send the selected media to be enhanced, along with the artifact/quality tag information 250 associated with the selected media, to the cloud. For example, the user of the electronic device 300 may connect to the cloud and send at least one command to the cloud to trigger the initiation of the media enhancement process on the selected media stored in the electronic device 300.

The media enhancement process may comprise identifying at least one AI-based media enhancement model that needs to be applied to the media 262 to enhance the media 262. In some embodiments, in response to the controller 101 being triggered to initiate the media enhancement process, the AI media enhancement unit 104 may start identifying one or more AI-based media enhancement models to be applied to the media 262 to enhance the media 262. For example, the AI media enhancement unit 104 may determine the type of the artifact or the degradation included in the image based on the artifact/quality tag information 250 associated with the media 262, and identify the AI-based media enhancement model based on the determined type of the artifact or the degradation associated with the media 262. Alternatively or additionally, one or more AI-based media enhancement blocks 104A-104N may be applied as an AI-based media enhancement model to the media 262.

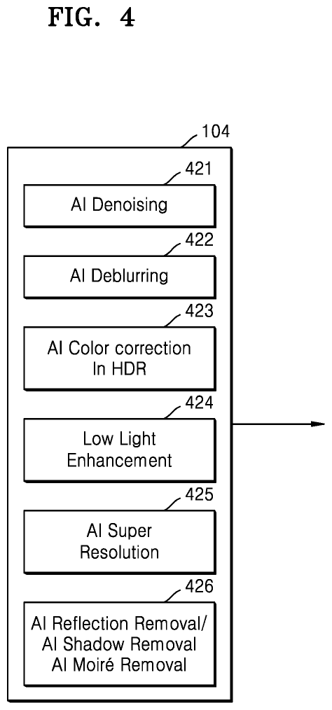

FIG. 4 illustrates examples of AI-based media enhancement models comprised by the AI media enhancement unit 104. In some embodiments, the AI-based media enhancement blocks 104A-104N may correspond to one or more AI-based media enhancement models (e.g., 421-426), as shown in FIG. 4. For example, the AI media enhancement unit 104 may comprise at least one of an AI denoising model 421, an AI debluring model 422, an AI color correction in High Dynamic Range (HDR) model 423, an AI low-light enhancement (e.g., night shot) model 424, an AI super resolution model 425, and a block 426 comprising an AI reflection removal model, an AI shadow removal model, and an AI Moiré model, and the like.

In some embodiments, one or more AI-based media enhancement models (e.g., 421-426) may be required to be applied to the media 262 for enhancing the media 262. That is, the one or more AI-based media enhancement models 421-426 may be configured to remove and/or nullify the artifacts and/or the degradations present in the media 262. For example, an AI-based media enhancement model (e.g., 421-426) may need to be applied for enhancing the media 262 as determined based on the artifact/quality tag information 250 associated with the media 262 As such, the media 262 may be sent to a corresponding AI-based media enhancement block (e.g., 104A-104N) for applying the one or more AI-based media enhancement models (e.g., 421-426) assigned to the corresponding AI-based media enhancement block (e.g., 104A-104N). By applying the one or more AI-based media enhancement models 421-426 to the image, according to the type of the artifact or the degradation of the image, the quality of the image may be enhanced. In some embodiments, the AI media enhancement unit 104 and the corresponding AI-based media enhancement blocks (e.g., 104A-104N) may be implemented in the cloud. In such embodiments, the enhancement process may be performed on the cloud, and the enhanced media may be obtained from the cloud. That is, the electronic device 100 may send the media to be enhanced to the cloud and receive the enhanced media from the cloud.

In some embodiments, an image may comprise a plurality of artifact and/or degradation types. In such embodiments, a plurality of AI-based media enhancement models 421-426 may be required to be applied to the media 262 for enhancing the media 262. In other embodiments, the AI media enhancement unit 104 may select a pipeline including a plurality of AI-based media enhancement models 421-426. The AI media enhancement unit 104 may determine one or more AI-based media enhancement models 421-426 to be applied to the media 262 based on the artifact/quality tag information 250, and may determine an order for applying the one or more AI-based media enhancement models 421-426. The media 262 may be sent to one or more of the AI-based media enhancement blocks 104A-104N and the AI-based media enhancement models 421-426 may be applied to the media 262 in a predetermined order, as indicated by the pipeline. For example, if or when an artifact/quality tag information 250 associated with an image indicates that the exposure of the image is ‘low’ and the resolution of the image is ‘low’, the image may be sent to the AI color correction in HDR model 423 followed by the AI super resolution model 425. The AI color correction in HDR model 423 may enhance the image by adjusting the exposure of the image, and the AI super resolution model 425 may enhance the image by upscaling the image. In such an example, the sequence of the AI-based media enhancement models to be applied in the pipeline may be the AI color correction in HDR model 423 followed by the AI super resolution model 425.

In another example, if or when artifact/quality tag information 250 associated with an image indicates that the image is captured in low light conditions (e.g., low-light tag 253 is set to ‘true’), the image is a blurred image (e.g., blur-type tag 254 is set to ‘defocus’), and there are noisy artifacts present in the image (e.g., noise tag 255 is set to ‘true’), the image may be sent to the AI denoising model 421, followed by the AI debluring model 422, which in turn may be followed by the AI low-light enhancement model 424. In such an example, the sequence of the pipeline may set from the AI denoising model 421 to the AI debluring model 422 and to AI low-light enhancement model 424. The sequence of AI-based media enhancement models to be applied may change, and is not limited by the examples above.

The pipeline, which may include one or more AI-based media enhancement models 421-426 for enhancing media 262, may be dynamically updated based on the artifacts and/or degradations present in the media 262. In some embodiments, the pipeline may be created by the AI enhancement mapper 108. For example, the AI enhancement mapper 108, in cooperation with the AI media enhancement unit 104, may be trained to find an optimal dynamic enhancement pipeline including a plurality of AI-based media enhancement models 421-426, to enhance the media 262. In some embodiments, the AI enhancement mapper 108 may be trained with a plurality of images and corresponding tag information provided to the AI enhancement mapper 108. In such embodiments, the AI enhancement mapper 108 may determine an optimal dynamic enhancement pipeline for the plurality of images and corresponding tag information that has been provided. After training of the AI enhancement mapper 108 has been completed, the AI enhancement mapper 108 may generate a similar optimal dynamic pipeline to be applied to images with similar characteristics and/or similar corresponding tag information to the images and corresponding tag information provided during the training period.

In some embodiments, the AI enhancement mapper 108 may generate pipelines based on, but not limited to, artifact/quality tag information 250 associated with the media 262, identified AI-based media enhancement models 421-426 to be applied to the media 262, dependency among the identified AI-based media enhancement models 421-426, aesthetic score of the media 262, content of the media 262, and the like.

The AI enhancement mapper 108 may be trained to generate sequences/orders (e.g., pipelines) of the AI-based media enhancement models applied to the media 262 for enhancing the media 262. The training of the AI enhancement mapper 108 may identify and/or create correlations between media having particular artifacts and/or degradations and particular sequences of the AI-based media enhancement models 421-426 to be added to the pipeline and applied to the media 262 in a particular order, for enhancing the media 262. For example, a media 262 having a reflection artifact and a low-resolution degradation may correlate with a pipeline sequence such as [AI reflection removal model 426—AI super resolution 425]. That is, after the AI enhancement mapper 108 has been trained and has been installed with the AI media enhancement unit 104, the AI enhancement mapper 108 may select pipelines to enhance the media 262, which may be stored in the memory 105, for example. In some embodiments, the AI enhancement mapper 108 may select pipelines comprising AI-based media enhancement models 421-426 that may correlate with particular artifacts and/or degradations present in the media 262. The AI-based media enhancement models 421-426 of the selected pipelines may be applied to the media 262 to enhance the media 262.

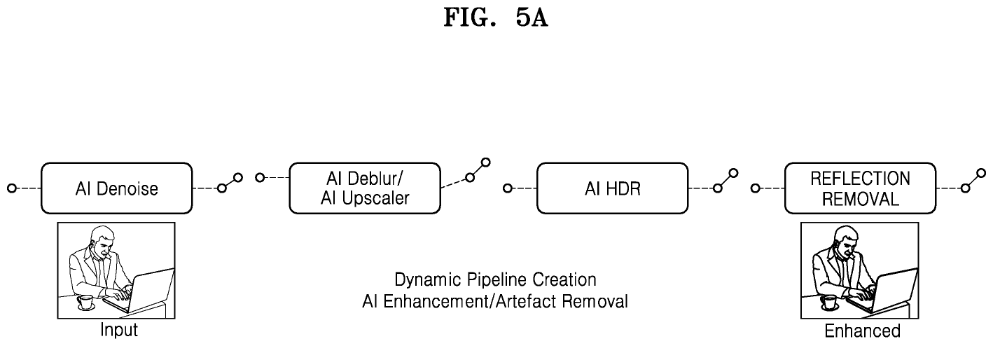

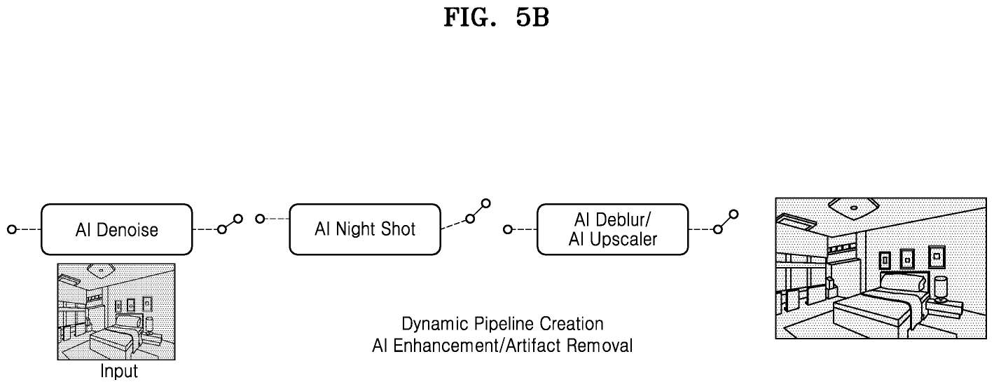

FIGS. 5A and 5B illustrate example image enhancements, wherein the enhancements have been obtained by applying multiple AI-based media enhancement models 421-426 in predetermined orders, according to embodiments as disclosed herein. The orders of the AI-based media enhancement models 421-426 may be determined during the training phase of the AI enhancement mapper 108 of the AI media enhancement unit 104.

For example, the AI media enhancement unit 104 may determine, based on the artifact/quality tag information 250 associated with an image, that a reflection artifact exists in the image, that the exposure of the image is ‘low’, that blur and noise is present in the image, and that the resolution of the image is ‘low’. In such an example, as illustrated in FIG. 5A, the AI media enhancement unit 104 may select, as the AI-based media enhancement models 421-426 to be applied to the image for image enhancement, the AI reflection removal model 426 for removing the reflection artifact present in the image, the AI denoising model 421 for removing the noise present in the image, the AI debluring model 422 for removing the blur present in the image, the AI color correction in HDR model 423 for increasing the exposure of the image, and the AI super resolution model for increasing the resolution of the image.

Alternatively or additionally, the AI media enhancement unit 104 may arrange the AI-based media enhancement blocks 104A-104N, that are applying the selected AI-based media enhancement models 421-426, in a pipeline in a predetermined order. As described above in reference to FIG. 4, the predetermined order may be determined during a training session of the AI enhancement mapper 108. For example, the pipeline sequence selected by the AI media enhancement unit 104 may be [AI denoising model 421—AI deblurring model 422—AI super resolution model 425 (e.g., AI upscaler)—AI color correction in HDR model 423—AI reflection removal model 426]. That is, in such an example, the pipeline may be configured to process an image by applying the AI denoising model 421 first, followed by the AI deblurring model 422, followed by the AI super resolution model 425, followed by the AI color correction in HDR model 423, and followed by the AI reflection model 426. As such, an enhanced version of the image may be obtained by applying the AI-based media enhancement models 421-426 to the image in the selected order according to the pipeline.

Continuing to refer to FIG. 5A, the AI denoising model 421 may be assigned to a first AI-based media enhancement block (e.g., 104A). That is, the first AI-based media enhancement block may remove and/or reduce the noise present on the image by applying the AI denoising model 421 to the image. Alternatively or additionally, the AI deblurring model 422 and the AI super resolution model 425 may be assigned to a second AI-based media enhancement block (e.g., 104B) such that the second AI-based media enhancement block may remove and/or reduce blurring present on the image and adjust the resolution of the image by applying the AI deblurring model 422 and the AI super resolution model 425, respectively. Alternatively or additionally, the AI color correction in HDR model 423 may be assigned to a third AI-based media enhancement block (e.g., 104C) and the AI reflection removal model 426 may be assigned to a fourth AI-based media enhancement block (e.g., 104N). As such, the third AI-based media enhancement block may adjust the exposure of the image by applying the AI color correction in HDR model 423 to the image, and the fourth AI-based media enhancement block may remove reflection artifacts present in the image by applying the AI reflection removal model 426 to the image.

Referring to FIG. 5B, the AI media enhancement unit 104 may determine, based on the artifact/quality tag information 250 associated with an image, that the image has been captured in low-lighting conditions, that blur and noise are present in the image, and that the resolution of the image is ‘low’. In such an example, the AI media enhancement unit 104 may determine that the AI-based media enhancement models 421-426 to be applied to the image for image enhancement may be the low-light enhancement model 424 (e.g., AI night shot) to increase the brightness of the image, the AI denoising model 421 to remove and/or reduce the noise present in the image, the AI debluring model 422 to remove and/or reduce the blur present in the image, and the AI super resolution model 425 (e.g., AI upscaler) to increase the resolution of the image.

Alternatively or additionally, the AI media enhancement unit 104 may arrange the AI-based media enhancement blocks 104A-104N, that are applying the selected AI-based media enhancement models 421-426, in a pipeline in a predetermined order. For example, the pipeline sequence selected by the AI media enhancement unit 104 may be [AI denoising model 421—AI low-light enhancement model 424 (e.g., AI night shot)—AI deblurring model 422—AI super resolution model 425 (e.g., AI upscaler)]. That is, the pipeline may indicate that the image may be sent to a first AI-based media enhancement block (e.g., 104A) that has been assigned the AI denoising model 421, followed by a second AI-based media enhancement block (e.g., 104B) that has been assigned the AI low-light enhancement model 424, and followed by a third AI-based media enhancement block (e.g., 104N) that has been assigned the AI deblurring model 422 and the AI super resolution model 425. As such, an enhanced version of the image may be obtained by applying the AI-based media enhancement models 421-426 to the image in the selected order according to the pipeline

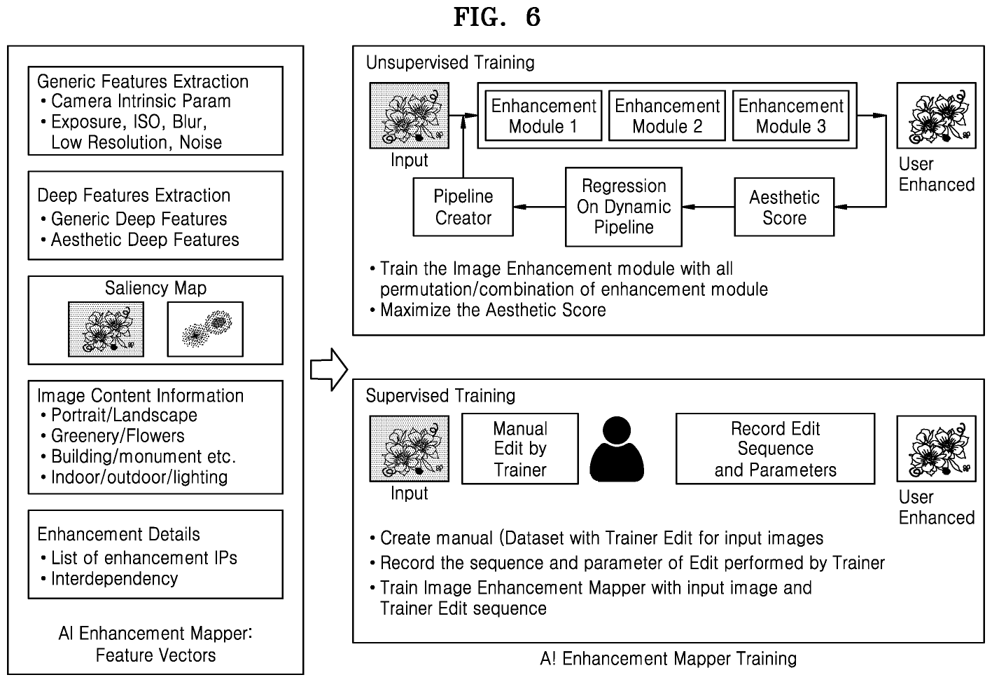

FIG. 6 illustrates supervised and unsupervised training of the AI enhancement mapper 108 to generate pipelines of AI-based media enhancement models 421-426, according to embodiments as disclosed herein. In some embodiments, the media used for training the AI enhancement mapper 108 may comprise an image. The image used during training may be referred to as a reference image. The AI enhancement mapper 108 may extract generic features such as intrinsic parameters of the camera used for capturing the reference image (if or when available), and artifact/quality tag information 250 associated with the reference image such as exposure, blur, noise, resolution, low-light, shadow, reflection, and the like. Alternatively or additionally, the AI enhancement mapper 108 may extract deep features from the reference image such as generic deep features and aesthetic deep features. The aesthetic deep feature may comprise an aesthetic score of the image. In some embodiments, the generic deep features may comprise content information of the reference image, type of the reference image such as whether the reference image is a landscape or a portrait image, objects detected in the reference image (e.g., flowers, humans, animals, structures, buildings, trees, things, and the like), environment (e.g., indoor or outdoor) in which the reference image has been captured, and the like.

In other embodiments, the AI enhancement mapper 108 may extract a saliency map of the reference image. Alternatively or additionally, the AI enhancement mapper 108 may identify the AI-based media enhancement models 421-426 that need to be applied to the reference image, for enhancement of the reference image. That is, the AI enhancement mapper 108 may identify one or more AI-based media enhancement models 421-426 for nullifying the effects of artifacts and/or degradations that may be included in the reference image. The AI enhancement mapper 108 may utilize the artifact/quality tag information 250 associated with the reference image for determining the artifacts and/or the degradations included in the reference image. The AI enhancement mapper 108 may determine dependencies among the AI-based media enhancement models 421-426 to be applied to the image for enhancement of the reference image. The generic features, deep features, saliency map, AI-based media enhancement models to be applied for enhancement of the reference image, and the dependencies among the AI-based media enhancement models, may be considered as feature vectors.

As depicted in FIG. 6, in the unsupervised training, the AI enhancement mapper 108 may create a pipeline of the identified AI-based media enhancement models 421-426, wherein the order of placement of the identified AI-based media enhancement models 421-426 may be based on the feature vectors. In some embodiments, the AI enhancement mapper 108 may evaluate the aesthetic score of the reference image after the identified AI-based media enhancement models 421-426 have been applied to the reference image in the order indicated in the pipeline. If or when the aesthetic score of the reference image increases (i.e., aesthetic score improves) compared to the aesthetic score of the reference image prior to the application of the identified AI-based media enhancement models 421-426, (i.e, the reference image has been enhanced), the the AI enhancement mapper 108 may apply the identified AI-based media enhancement models 421-426 to the enhanced reference image again. The process of applying the identified AI-based media enhancement models 421-426 may continue until the aesthetic score reaches a saturation value. That is, the process of applying the identified AI-based media enhancement models 421-426 may continue until the aesthetic score reaches a highest possible value (i.e., the aesthetic score is maximized).

Alternatively or additionally, if or when the AI enhancement mapper 108 determines that the aesthetic score of the reference image has not increased (and/or decreased) compared to the aesthetic score of the reference image prior to the application of the identified AI-based media enhancement models 421-426, the pipeline may be updated by changing the order of placement of the identified AI-based media enhancement models 421-426. Thereafter, the identified AI-based media enhancement models 421-426 may be reapplied to the reference image in the updated order, and the aesthetic score may be re-evaluated. If or when the aesthetic score improves, application of the identified AI-based media enhancement models in the updated order, to the reference image, may be continued until the aesthetic score reaches the saturation value.

In some embodiments, the AI enhancement mapper 108 may generate multiple pipelines by varying the placement of the identified AI-based media enhancement models 421-426 in the pipelines. Alternatively or additionally, the AI enhancement mapper 108 may obtain aesthetic scores after applying the identified AI-based media enhancement models 421-426 to the reference image in the orders indicated in each of the pipelines. The AI enhancement mapper 108 may select at least one pipeline based on an improvement to the aesthetic score of the reference image, wherein the improvement in the aesthetic score is obtained by applying the identified AI-based media enhancement models 421-426 to the reference image in the order corresponding to the selected pipeline. The AI enhancement mapper 108 may select an order of AI-based media enhancement models 421-426 of the pipeline, among the at least one selected orders of the pipeline, which maximizes the aesthetic score of the reference image if or when the AI-based media enhancement models 421-426 are applied to the reference image in that corresponding order.

In some embodiments, the AI enhancement mapper 108 may determine that an optimal pipeline comprising an optimal set of the AI-based media enhancement models 421-426, which may have been identified based on the feature vectors of the reference image and may be arranged in an optimal order, cause the aesthetic score of the reference image to reach the saturation value (e.g., a maximum value). The AI enhancement mapper 108 may be configured, in a synthesis phase, to use the optimal pipeline to enhance media 262 having similar feature vectors as the reference image. That is, after the AI enhancement mapper 108 has been trained, the AI enhancement mapper 108 may utilize the optimal pipeline for enhancement of media 262, if or when feature vectors of the media 262 match or relate to the feature vectors of the reference image. For example, the AI enhancement mapper 108 may apply the optimal set of the AI-based media enhancement models 421-426 in the optimal order indicated in the optimal pipeline to the media 262 for media enhancement. Consequently, the AI enhancement mapper 108 may apply the same optimal pipeline to images with similar characteristics (e.g., feature vectors).

Continuing to refer to FIG. 6, in the supervised training, a trainer (e.g., a person) may create a manual pipeline by manually selecting an order for applying the identified AI-based media enhancement models 421-426 to the reference image, for enhancing the reference image. The selection may be recorded and a correspondence may be created between the reference image and the order of the manual pipeline for applying the identified AI-based media enhancement models 421-426, wherein the identified AI-based media enhancement models 421-426 may have been identified based on the feature vectors of the reference image. In the synthesis phase, if or when the AI enhancement mapper 108 has determined that the feature vectors of an image match with, or may be similar to, the feature vectors of the reference image, the AI enhancement mapper 108 may apply the identified AI-based media enhancement models 421-426 in the order of the manual pipeline selected by the trainer during the training phase.

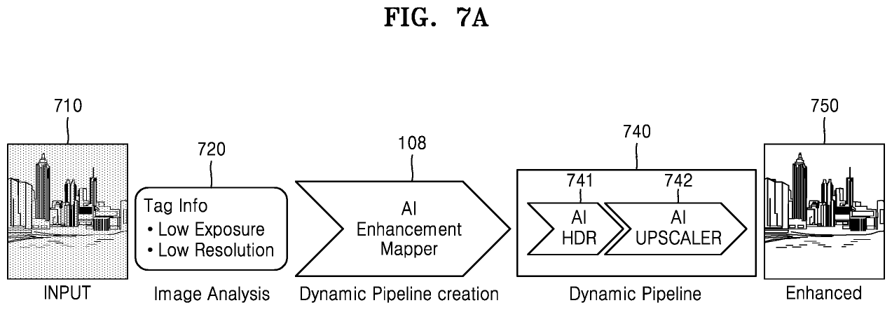

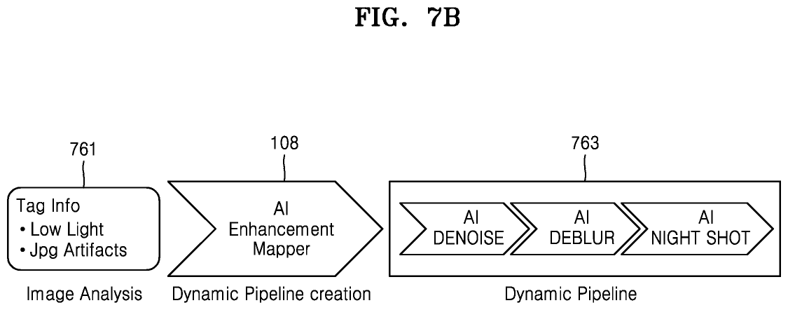

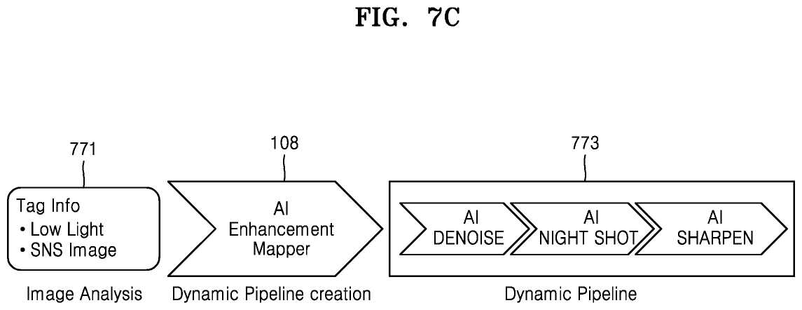

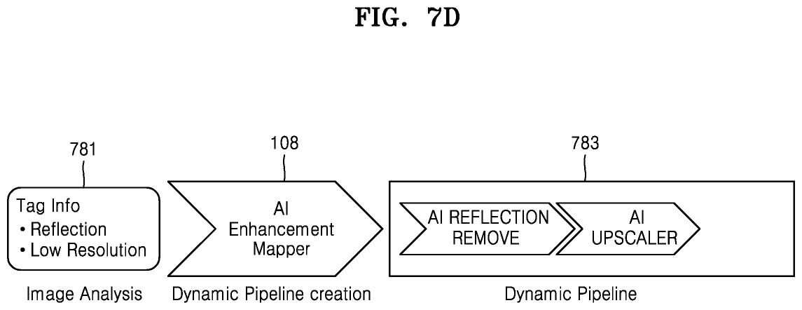

FIGS. 7A, 7B, 7C, and 7D each illustrate an example enhancement of an image using AI-based media enhancement models arranged in a pipeline, according to embodiments as disclosed herein. In some embodiments described in FIGS. 7A, 7B, 7C, and 7D, the AI enhancement mapper 108 may not have been previously trained. In other embodiments, the AI enhancement mapper 108 may analyze an example input image 710 and corresponding artifact/quality tag information 720 associated with the input image 710. The AI enhancement mapper 108 may identify the AI-based media enhancement models 421-426 that may need to be applied to the input image 710 in order to enhance the input image 710.

Referring to FIG. 7A, the AI enhancement mapper 108 may determine that the exposure level of input image 710 is low and that the resolution of the input image 710 is low, based on the artifact/quality tag information 720 associated with the input image 710, for example. In some embodiments, the AI enhancement mapper 108 may identify that an AI HDR model 741 and that an AI upscaler model 742 may need to be applied to the input image 710, based on the image analysis performed by the AI enhancement mapper 108, for enhancing the input image 710. That is, the AI enhancement mapper 108 may determine that the AI HDR model 741 needs to be applied in order to adjust the exposure level of the input image 710 (e.g., similar to AI color correction in HDR model 423). Alternatively or additionally, the AI enhancement mapper 108 may determine that the AI upscaler model 742 needs to be applied in order to adjust the resolution of the input image 710 (e.g., similar to AI super resolution model 425).

The AI enhancement mapper 108 may be further configured to create a pipeline 740 of the AI-based media enhancement blocks 104A-104N implementing the AI-based media enhancement models. For example, as shown in FIG. 7A, the AI enhancement mapper 108 may create the pipeline 740 comprising AI-based media processing blocks 104A-104N implementing the identified AI-based media enhancement models (i.e., the AI HDR model 741 and the AI upscaler model 742). The pipeline 740 of AI-based media processing blocks 104A-104N may be generated based on feature vectors of the input image 710 and the artifact/quality tag information 720 associated with the input image 710, the identified AI-based media enhancement models (e.g., the AI HDR model 741 and the AI upscaler 742), dependency between the AI HDR model 741 and the AI upscaler model 742, aesthetic score of the input image 710, a saliency map pertaining to the input image 710, and content of the input image 710. As depicted in FIG. 7A, the pipeline 740 may first apply the AI with HDR model 741 to the input image 710, and may then apply the AI upscaler model 742 to the input image 710 in order to generate the enhance output image 750.

Referring to FIG. 7B, the AI enhancement mapper 108 may determine that the image has been captured in low light conditions and has jpg artifacts (e.g., compression artifacts), based on the artifact/quality tag information 761 associated with the image. As a result, the AI enhancement mapper 108 may identify that AI-based media enhancement models 763 such as the AI denoising model 421, the AI deblurring model 422, and the AI low light enhancement model 424, may need to be applied to the image for enhancing the image.

Referring to FIG. 7C, the AI enhancement mapper 108 may determine that the image has been captured in low light conditions and the type of the image is a social networking service (SNS) image, based on the artifact/quality tag information 771 associated with the image. As a result, the AI enhancement mapper 108 may identify that AI-based media enhancement models 773 such as the AI denoising model 421, the AI low light enhancement model 424, and an AI sharpen model, may need to be applied to the image for enhancing the image.

Referring to FIG. 7D, the AI enhancement mapper 108 may determine that the image has been captured in low light conditions and has reflection artifacts, based on the artifact/quality tag information 781 associated with the image. As a result, the AI enhancement mapper 108 may identify that AI-based media enhancement models 783, such as the AI reflection removal model 426, and the AI upscaler model 742, may need to be applied to the image for enhancing the image.

In some embodiments, the AI enhancement mapper 108 may stop changing the pipeline if or when applying the AI-based media processing blocks in the order indicated in the pipeline allows for maximizing the aesthetic score of the input image. In other embodiments, an operator and/or trainer may select the pipeline for enhancing the input image based on the feature vectors associated with the input image. In the synthesis phase, the AI enhancement mapper 108 may select the same pipeline for enhancing an image, if or when the feature vectors of the image are identical with, or similar to, the feature vectors of the input image used for training.

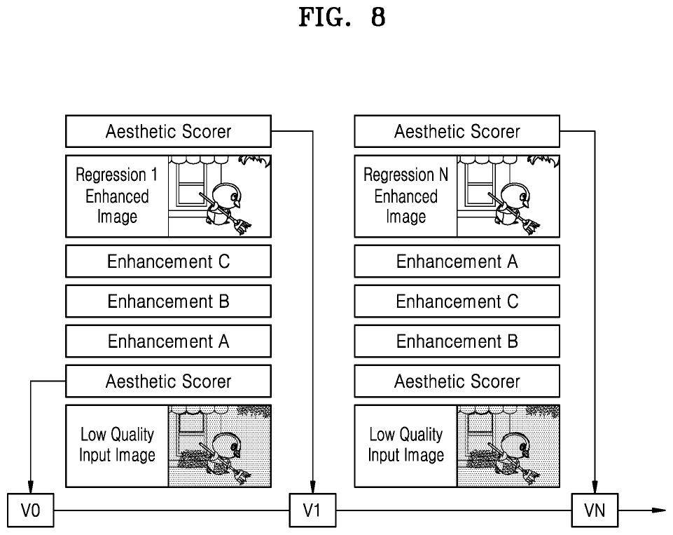

FIG. 8 illustrates an example unsupervised training of the AI enhancement mapper 108 for enabling correspondence between a pipeline of AI-based media enhancement models and an image with particular artifacts and/or degradations, according to embodiments as disclosed herein. As depicted in FIG. 8, the unsupervised training may be based on validating the enhancement of the image by checking whether the aesthetic score of the image has improved after applying the AI-based media enhancement models (e.g., Enhancement A, Enhancement B, Enhancement C) in different orders. The training may allow for the creation of a pipeline of the AI-based media enhancement models, by determining an optimal sequence (e.g., order) in which the AI-based media enhancement models may need to be applied to the image such that the aesthetic score of the image is maximized (e.g., reaches a saturation value). For example, the AI-based media enhancement models may comprise Enhancement A, Enhancement B, and Enhancement C. In such an example, based on the feature vectors of the image, the selected sequence for applying the AI-based media enhancement models on the image may be Enhancement A, followed by Enhancement B, and followed by Enhancement C. That is, the pipeline created by the AI enhancement mapper 108 may be [Enhancement A—Enhancement B—Enhancement C] in order.

In some embodiments, the AI enhancement mapper 108 may evaluate the aesthetic score V₁ of the regression 1 enhanced image after the low quality input image has been enhanced according to the order of AI-based media enhancement models indicated by the pipeline. For example, the AI enhancement mapper 108 may compare the aesthetic score V₁ of the regression 1 enhanced image with the aesthetic score V₀ of the low quality input image, after applying the Enhancement A, the Enhancement B, and the Enhancement C, to the low quality input image in the order indicated in the pipeline. If or when the AI enhancement mapper 108 determines that there is no significant improvement in the aesthetic score (e.g., a difference between V₁ and V₀ is less than a threshold), the AI enhancement mapper 108 may change the sequence (e.g., order) for applying the AI-based media models on the image. For example, the AI enhancement mapper 108 may change, in an N^{th} recursion, the pipeline to have an order for applying the AI-based media enhancement models of [Enhancement B—Enhancement C—Enhancement A]. As such, the AI enhancement mapper 108 may apply the AI-based media enhancement models to the low quality input image, according to the order indicated by the changed pipeline, resulting in a regression N enhanced image. Alternatively or additionally, the AI enhancement mapper 108 may calculate aesthetic score V_{N} for the regression N enhanced image. In some embodiments, the aesthetic score V_{N} may correspond to a highest or maximum value that the aesthetic score of the low quality input image may attain.

In some embodiments, the AI enhancement mapper 108 may create a correspondence between the low quality input image and the selected pipeline [Enhancement B—Enhancement C—Enhancement A]. During the synthesis phase, if or when an input image having similar artifacts and/or degradations needs to be enhanced and the feature vectors of the input image and the feature vectors of the image used for training are similar (or same), the AI enhancement mapper 108 may select the pipeline [Enhancement B—Enhancement C—Enhancement A] for enhancing the image.

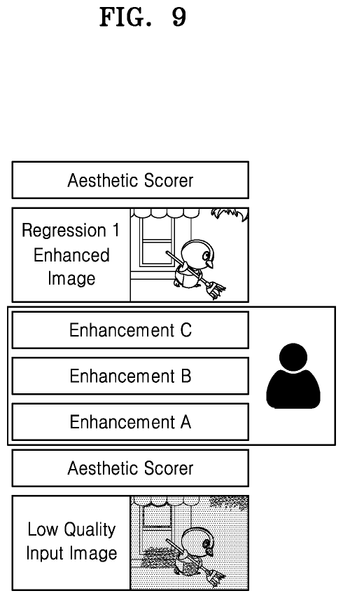

FIG. 9 illustrates an example of supervised training of the AI enhancement mapper 108 for enabling correspondence between a pipeline of AI-based media enhancement models and an image having particular artifacts and/or degradations, according to embodiments as disclosed herein. As depicted in FIG. 9, the training may be supervised by an expert (e.g., trainer, operator). The expert may create a pipeline of AI-based media enhancement models, by determining the optimal sequence in which the AI-based media enhancement models may need to be applied to the image for enhancing the image. For example, the AI-based media enhancement models may comprise Enhancement A, Enhancement B, and Enhancement C, and, based on the feature vectors of the image, the pipeline created by the expert may be [Enhancement A—Enhancement B—Enhancement C].

If or when the pipeline is created, the AI enhancement mapper 108 may create a correspondence between the image and the pipeline [Enhancement A—Enhancement B—Enhancement C]. During the synthesis phase, if or when an input image having similar artifacts and/or degradations needs to be enhanced and the feature vectors of the input image and the feature vectors of the image used for training are detected to be similar (or same), the AI enhancement mapper 108 may select the pipeline [Enhancement A—Enhancement B—Enhancement C] for enhancing the image.

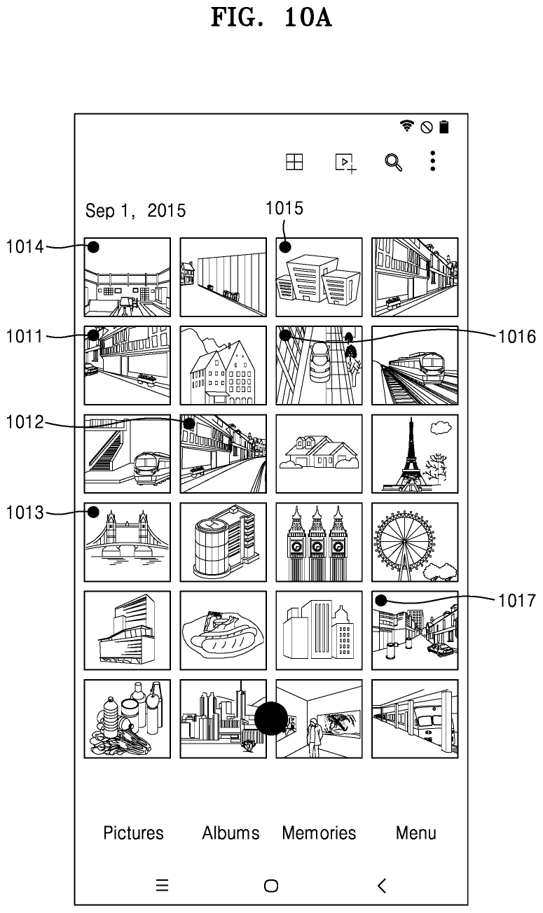

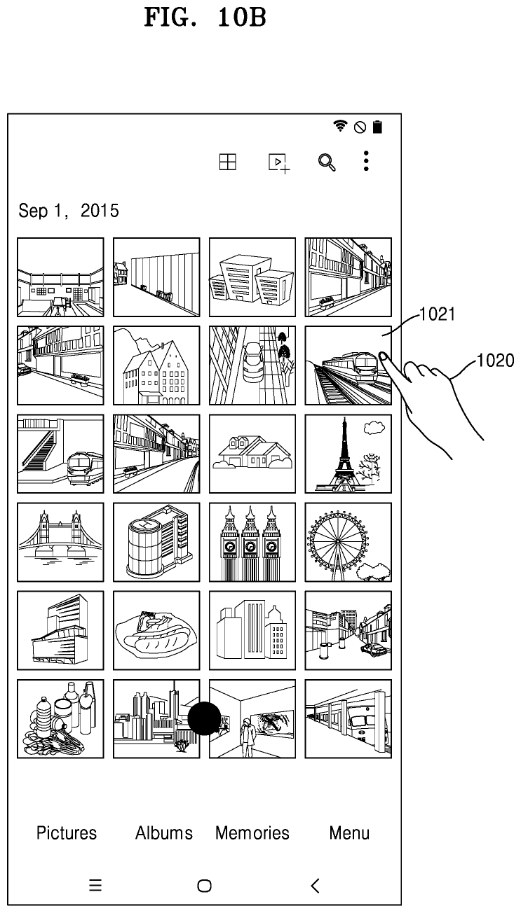

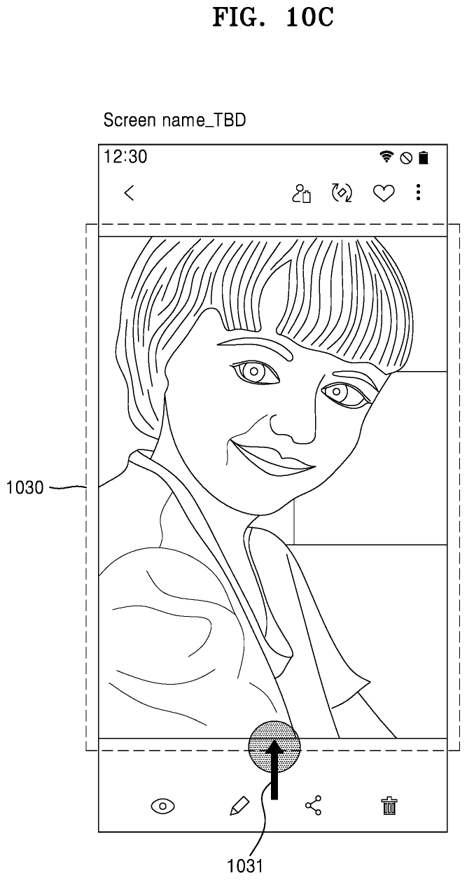

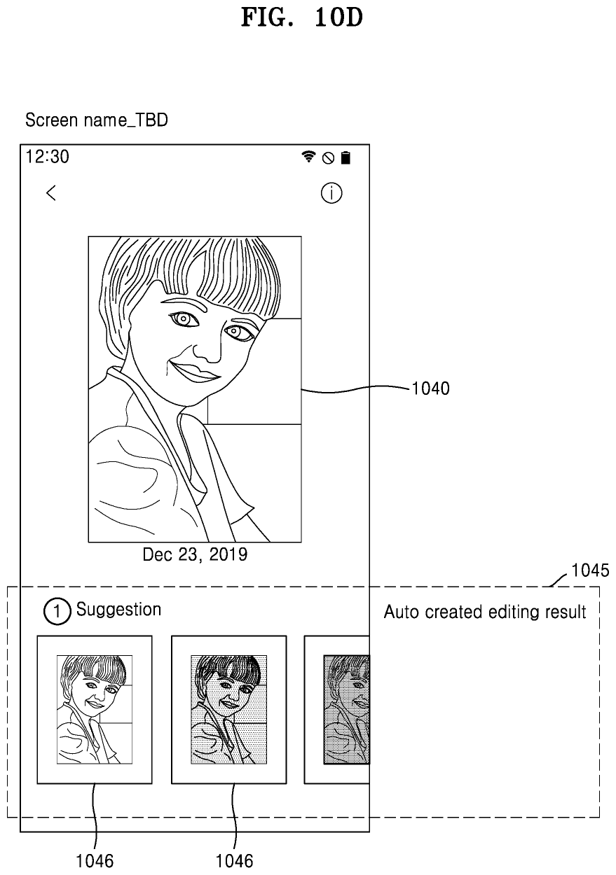

FIGS. 10A, 10B, 10C, and 10D illustrate an example user interface (UI) for displaying options to a user to select images, stored in the device, for enhancement, and displaying an enhanced version of a selected image, according to embodiments as disclosed herein;

FIGS. 10A, 10B, 10C, and 10D illustrate an example UI for displaying options to a user to select images, that may be stored in the electronic device 100, for enhancement, and displaying an enhanced version of a selected image, according to embodiments as disclosed herein. In some embodiments, as depicted in FIG. 10A, the images 1011, 1012, 1013, 1015, 1016, and 1017 available for enhancement may be marked and indicated to the user. The marked images 1011, 1012, 1013, 1015, 1016, 1017 may be prioritized for enhancement if or when at least one of the aesthetic score of the marked images is low, the saliency of the marked images is high, and/or the image may be enhanced. In other embodiments, the marked images 1011, 1012, 1013, 1015, 1016, 1017 may be displayed if or when the device has detected artifacts and/or degradations in the marked images, and/or if or when the user has configured the UI to manually initiate the application of AI-based media enhancement models to the marked images to remove or nullify the detected artifacts and/or degradations present in the images, or if or when the triggering of application of AI-based media enhancement models is set to manual by default.

In other embodiments, the images that have been enhanced may be marked and indicated to the user. For example, the UI depicted in FIG. 10A may be displayed if or when the user has configured the UI to automatically trigger the detection of artifacts and/or degradations in the images and/or the detection of enhancements of the images, or if or when the triggering of detection of artifacts and/or degradations in the images and/or the detection of enhancements of the images is set to automatic by default.

Referring to FIG. 10B, the user 1020 may select the image 1021 to be enhanced. The user 1020 may select the image 1021 to be enhanced and/or manually trigger the detection of artifacts/degradations in the images and/or the detection of the enhancements of the images, if or when the triggering of the detection is set to be initiated manually by default. If or when the user 1020 has configured to automatically initiate the triggering of detection of artifacts/degradations in the images and/or the detection of enhancements of the images, and/or if or when the triggering of the detection is set to be initiated automatically by default, the UI depicted in FIG. 10B may not be displayed to the user 1020.

Referring to FIG. 10C, the user may have selected an image 1030, among the marked images, for initiating the detection of artifacts/degradations in the selected image, and/or initiating the application of AI-based media enhancement models to the selected image 1030. The UI depicted in FIG. 10C may display the image 1030 and may indicate the gesture 1031 that may be required for initiating the detection of artifacts/degradations in the selected image, and/or initiating the application of AI-based media enhancement models to the selected image 1030. In some embodiments, the gesture 1031 may be a ‘swipe-up’, for example. If or when the user inputs the gesture 1031 that indicates the initiation of the detection of artifacts/degradations in the image 1030, then the detection of artifacts/degradations in the selected image 1030 may be automatically performed and at least one AI-based media enhancement model may be applied to the image 1030 for enhancing the image 1030.

Referring to FIG. 10D, the UI may display the enhanced images 1046, 1047 obtained after applying at least one AI-based media enhancement model to the image 1040 in a predetermined order.

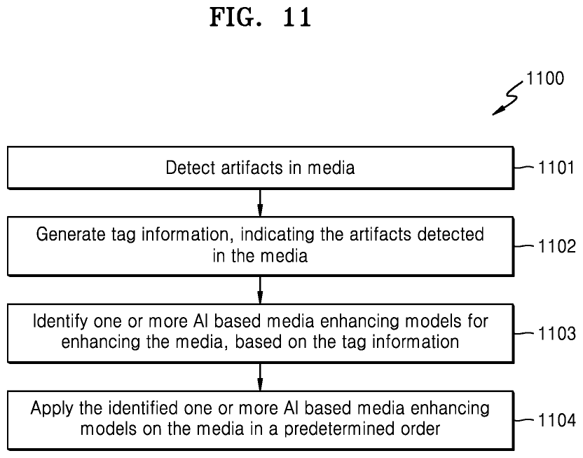

FIG. 11 depicts a flowchart 1100 of a method for enhancing the quality of media by detecting presence of artifacts and/or degradations in the media and nullifying the artifacts and the degradations using one or more AI-based media enhancement models, according to embodiments as disclosed herein.

In operation 1101, the method 10 comprises detecting a presence of artifacts and/or degradations in the media 262. The triggering of the detection of the artifacts and/or the degradations may be automatic or manual. In some embodiments, the detecting at operation 1101 may comprise determining aesthetic scores of the media 262 and saliency of the media 262. In optional or additional embodiments, the detecting at operation 1101 may comprise prioritizing the media 262 for enhancement based on the aesthetic scores and the saliency of the media 262. For example, media 262 having a low aesthetic score and a high degree of saliency may be prioritized. The prioritization may allow for indicating the media 262 that is available for enhancement, which may further allow for manual triggering of detection of artifacts and/or the degradations in the media 262 and/or may further allow for automatic triggering of the detection of the artifacts and/or the degradations in the media 262.

At operation 1102, the method comprises generating artifact/quality tag information 250, which may indicate the artifacts and/or degradations detected in the media 262. In some embodiments, the generating at operation 1102 may comprise creating a mapping between media 262 and artifact/quality tag information 250 associated with the media 262 (e.g., artifacts and/or degradations that have been detected in the media 262). In optional or additional embodiments, the generating at operation 1102 may comprise storing the artifact/quality tag information 250 along with the media 262 as metadata, and/or in a dedicated database. The database may indicate the media 262 and the artifacts and/or degradations associated with the media 262. The artifact/quality tag information 250 may allow classification of media based on specific artifacts and/or degradations present in the media 262.

In operation 1103, the method comprises identifying one or more AI-based media enhancing models 421-426 for enhancing the media 262, (e.g., improving the quality of the media 262), based on the artifact/quality tag information 250. In some embodiments, the identifying at operation 1103 may comprise identifying the one or more AI-based media enhancement models 421-426, which may need to be applied to the media 262 to enhance the media 262, based on the artifact/quality tag information 250 associated with the media 262. In optional or additional embodiments, the identifying at operation 1103 may comprise applying the one or more identified AI-based media enhancement models 421-426 for removing or nullifying the artifacts and/or degradations that have been detected in the media 262. In other optional or additional embodiments, the identifying at operation 1103 may be triggered manually or automatically. In other optional or additional embodiments, the identifying at operation 1103 may be triggered automatically if or when the detection of the artifacts and/or degradations in the media 262 is configured to be triggered automatically. In other optional or additional embodiments, the identifying at operation 1103 may triggered manually in response to receiving one or more commands from a user.

In operation 1104, the method comprises applying the identified one or more AI-based media enhancing models 421-426 to the media 262 in a predetermined order. In some embodiments, a single AI-based media enhancing model 421-426 may be identified, which may need to be applied to the image for enhancing the media 262, for nullifying the artifacts and/or degradations that have been detected in the media 262, such that the identified single AI-based media enhancing model 421-426 may be applied directly to the media 262. In other embodiments, multiple AI-based media enhancing models 421-426 may have been identified for application to the media 262 for enhancing the media 262, such that the AI-based media enhancing models 421-426 may need to be applied to the media 262 in the predetermined order/sequence. In optional or additional embodiments, the applying at operation 1104 may comprise selecting a pipeline of the AI-based media enhancing models 421-426, wherein the identified AI-based media enhancing models 421-426 may be arranged in a predetermined order. In optional or additional embodiments, the applying at operation 1104 may comprise updating the pipelines of the identified AI-based media enhancing models 421-426 based on the identified AI-based media enhancement models 421-426 required (to be applied to the media 262) to enhance the media 262.

In optional or additional embodiments, the applying at operation 1104 may comprise creating pipelines of the AI-based media enhancement models 421-426, to be applied to the media 262 to enhance the media 262. The pipelines may be created offline (e.g., during a training phase), wherein correspondences may be created between media with specific artifacts and/or degradations (which have been detected in the media) and specific sequences of AI-based media enhancement models 421-426. In such embodiments, the AI-based media enhancement models 421-426 may be applied to the media 262 (for enhancing the media 262) in the specific sequences. The sequences are determined during the training phase and may be referred to as the predetermined order during the synthesis phase.

In optional or additional embodiments, the applying at operation 1104 may comprise creating the correspondences based on the feature vectors of the media 262 such as the artifact/quality tag information 250 associated with the media 262, identified AI-based media enhancement models 421-426 to be applied to the media 262, dependency amongst the identified AI-based media enhancement models 421-426, aesthetic score of the media 262, content of the media 262, and the like.

In optional or additional embodiments, the applying at operation 1104 may comprise ensuring the optimality of the enhancement of the media 262 by determining that aesthetic score of the media 262 has reached a maximum value after the enhancement. In optional or additional embodiments, the applying at operation 1104 may comprise applying the AI-based media enhancement models 421-426 recursively to the media 262 and determining the aesthetic score of the media 262, until the aesthetic score of the media 262 has reached a maximum value.

The various actions in the flowchart 1100 may be performed in the order presented, in a different order, or simultaneously. Further, in some embodiments, some actions listed in FIG. 11 may be omitted.

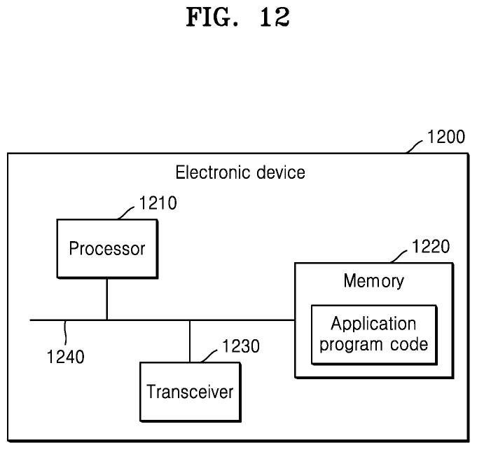

FIG. 12 illustrates a block diagram of an electronic device provided by an embodiment of the present application. In an alternative embodiment, an electronic device 1200 is provided. As shown in FIG. 12, the electronic device 1200 may comprise a processor 1210 and a memory 1220. The processor 1210 may be connected to the memory 1220, for example, via a bus 1240. Alternatively or additionally, the electronic device 1200 may further comprise a transceiver 1230. It should be noted that in practical disclosures, the number of transceivers 1230 is not limited to one, and that the structure of the electronic device 1200 does not limit the embodiments of the present disclosure.

The processor 1210 may be a central processing unit (CPU), a general-purpose processor, a digital signal processor (DSP), an application specific integrated circuit (ASIC), a domain programmable gate array (FPGA), or other programmable logic devices, transistor logic devices, hardware components, or any combination thereof. It is possible to implement or execute the various exemplary logical blocks, modules and circuits described in combination with the disclosures of the present disclosure. The processor 1210 may also be a combination of computing functions, such as a combination of one or more microprocessor, a combination of a DSP and a microprocessor, and the like.

The bus 1240 may comprise a path for communicating information between the above components. The bus 1240 may be a peripheral component interconnect (PCI) bus or an extended industry standard architecture (EISA) bus. The bus 1240 may be divided into an address bus, a data bus, a control bus, and the like. For the sake of simplicity, FIG. 12 depicts one line to represent the bus 1240, however, such a depiction does not limit the number of busses and/or the type of busses that communicatively couple the processor 1210, the memory 1220, and the transceiver 1230.

The memory 1220 may be a read only memory (ROM) and/or other type of static storage device that may store static information and instructions, random access memory (RAM) and/or other types of dynamic storage device that may store information and instructions. Alternatively or additionally, the memory 1220 may comprise an electrically erasable programmable read only memory (EEPROM), a compact disc read only memory (CD-ROM) and/or other optical disc storage, such as compression optical discs, laser discs, optical discs, digital versatile discs, Blu-ray discs, and the like, magnetic disk storage media and/or other magnetic storage devices, and/or any other non-transitory computer-readable storage medium that may be used to carry or store desired program code in the form of instructions or data structures and may be accessed by a computer, but not limited to this. Non-transitory computer-readable storage media may exclude transitory signals.

The memory 1220 may be used to store application program code that, when executed by the processor 1210, may implement one or more embodiments of the present disclosure. The processor 1210 may be configured to execute application program code stored in the memory 1220 to implement the features described in any of the foregoing embodiments.

In some embodiments, the electronic device 1200 may comprise, but is not limited to, a mobile terminal, such as a mobile phone, a notebook computer, a digital broadcast receiver, a personal digital assistant (PDA), a portable android device (PAD), a portable multimedia player (PMP), an in-vehicle terminal (for example, a car navigation terminal) and the like, as well as a fixed terminal such as digital TV, a desktop computer and the like. The electronic device 1200 shown in the FIG. 12 is merely an example, and as such, should not construct any limitation on the function and scope of use of the embodiments of the present disclosure.

The embodiments disclosed herein can be implemented through at least one software program running on at least one hardware device and performing network management functions to control the network elements. The computing elements shown in FIG. 12 may comprise blocks which can be at least one of a hardware device, or a combination of hardware device and software module.

The embodiments disclosed herein describe methods and systems for enhancing quality of media stored in a device or cloud by detecting artifacts and/or degradations in the media, identifying at least one AI-based media enhancement model for nullifying the detected artifacts and/or degradations, and enhancing the media by applying the at least one AI-based media enhancement model in a predetermined order for enhancing the media. Therefore, it is understood that the scope of the protection is extended to such a program and in addition to a computer-readable storage means having a message therein, such computer-readable storage means may contain program code means for implementation of one or more steps of the method, when the program runs on a server or mobile device or any suitable programmable device. The method is implemented in a preferred embodiment through or together with a software program written in example Very high speed integrated circuit Hardware Description Language (VHDL), or any other programming language, or implemented by one or more VHDL or several software modules being executed on at least one hardware device. The hardware device can be any kind of portable device that can be programmed. The device may further comprise means, which could be, for example, a hardware means, for example, an Application-specific Integrated Circuit (ASIC), or a combination of hardware and software means, for example, an ASIC and a Field Programmable Gate Array (FPGA), or at least one microprocessor and at least one memory with software modules located therein. The method embodiments described herein could be implemented partly in hardware and partly in software. Alternatively, the invention may be implemented on different hardware devices, e.g. using a plurality of Central Processing Units (CPUs).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for enhancing media, comprising:
detecting at least one artifact included in the media based on tag information indicating the at least one artifact included in the media;
identifying at least one artificial intelligence (AD-based media enhancement model, the at least one AI-based media enhancement model being configured to enhance the at least one artifact detected in the media; and
enhancing the media by applying the at least one AI-based media enhancement model to the media.

2. The method of claim 1, further comprising:
encrypting the tag information regarding the media; and
storing the encrypted tag information with the media as metadata of the media.

3. The method of claim 1, wherein the detecting the at least one artifact comprises determining whether an aesthetic score of the media fails to meet a predefined threshold.

4. The method of claim 1, wherein the identifying the at least one AI-based media enhancement model comprises:
identifying a type of the at least one artifact based on the tag information; and
determining the at least one AI-based media enhancement model according to the type of the at least one artifact.

5. The method of claim 1, wherein the identifying the at least one AI-based media enhancement model comprises determining a type of the at least one AI-based media enhancement model and an order of the at least one AI-based media enhancement model.

6. The method of claim 5, wherein:
the identifying the at least one AI-based media enhancement model further comprises determining a plurality of AI-based media enhancement models for enhancing the at least one artifact detected in the media; and
the applying the at least one AI-based media enhancement model comprises applying the plurality of AI-based media enhancement models to the media according to a predetermined order.

7. The method of claim 1, wherein the identifying the at least one AI-based media enhancement model comprises:
determining a type of a reference AI-based media enhancement model and an order of the reference AI-based media enhancement model, the reference AI-based media enhancement model being configured to enhance a reference media;
storing, in a database, the type and the order of the reference AI-based media enhancement model;
obtaining feature vectors of the media; and
determining a type of the at least one AI-based media enhancement model and an order of the at least one AI-based media enhancement model according to the type and the order of the reference AI-based media enhancement model, wherein the reference media has similar feature vectors with the media.

8. The method of claim 7, wherein the feature vectors of the media comprise at least one of: metadata of the media, the tag information, an aesthetic score of the media, a plurality of AI-based media enhancement models to be applied to the media, dependencies among the plurality of AI-based media enhancement models, and the media.

9. An electronic device for enhancing media, the electronic device comprising:
a memory;
one or more processors communicatively connected to the memory and configured to:
detect at least one artifact included in the media based on tag information indicating the at least one artifact included in the media;
identify at least one artificial intelligence (AI)-based media enhancement model, the at least one AI-based media enhancement model being configured to enhance the at least one artifact detected in the media; and
enhance the media by applying the at least one AI-based media enhancement model to the media.

10. The electronic device of claim 9, wherein the one or more processors are further configured to:
encrypt the tag information regarding the media; and
store the encrypted tag information with the media as metadata of the media.

11. The electronic device of claim 9, wherein to detect the at least one artifact determines whether an aesthetic score of the media fails to meet a predefined threshold.

12. The electronic device of claim 9, wherein the one or more processors are further configured to:
identify a type of the at least one artifact based on the tag information; and
determine the at least one AI-based media enhancement model according to the type of the at least one artifact.

13. The electronic device of claim 9, wherein the one or more processors are further configured to determine a type of the at least one AI-based media enhancement model and an order of the at least one AI-based media enhancement model.

14. The electronic device of claim 13, wherein the one or more processors are further configured to:
determine a plurality of AI-based media enhancement models for enhancing the at least one artifact detected in the media; and
apply the plurality of AI-based media enhancement models to the media according to a predetermined order.

15. The electronic device of claim 9, wherein the one or more processors are further configured to:
determine a type of a reference AI-based media enhancement model and an order of the reference AI-based media enhancement model, the reference AI-based media enhancement model being configured to enhance a reference media;
store, in a database, the type and the order of the reference AI-based media enhancement model;
obtain feature vectors of the media; and
determine a type of the at least one AI-based media enhancement model and an order of the at least one AI-based media enhancement model according to the type and the order of the reference AI-based media enhancement model, wherein the reference media has similar feature vectors with the media.

16. The electronic device of claim 15, wherein the feature vectors of the media comprise at least one of: metadata of the media, the tag information, an aesthetic score of the media, a plurality of AI-based media enhancement models to be applied to the media, dependencies among the plurality of AI-based media enhancement models, and the media.
